(19) United States
(12) Patent Application Publication
(10) Pub. No.: US 2024/0345974 A1
(43) Pub. Date: Oct. 17, 2024

(54) ELECTRONIC DEVICE FOR PERFORMING COMMUNICATIONS WITH MASTER DEVICE BY SERIAL COMMUNICATIONS BUS AND METHOD FOR PERFORMING ASSIGNMENT OF IDENTIFIER ON ELECTRONIC DEVICE

(71) Applicant: Realtek Semiconductor Corp., HsinChu (TW)

(72) Inventors: Tsung-Peng Chuang, HsinChu (TW); Jer-Ming Chang, HsinChu (TW)

(21) Appl. No.: 18/624,092

(22) Filed: Apr. 1, 2024

(30) Foreign Application Priority Data
Apr. 11, 2023 (TW) 112113443

(51) Int. Cl. G06F 13/362; G06F 13/42

(52) U.S. Cl. CPC G06F 13/3625; G06F 13/4291

(57) ABSTRACT

An electronic device for performing communication with a master device via a serial communications bus and a method for performing assignment of an identifier on the electronic device are provided, wherein the master device is coupled to multiple slave devices via the serial communications bus, and the multiple slave devices include the electronic device. The electronic device includes a clock terminal, a data terminal, and a determination circuit coupled to the clock terminal and the data terminal, wherein the clock terminal and the data terminal receive a first signal and a second signal from the master device, respectively. The determination circuit determines whether a time point of pulling down the first signal is earlier than a time point of pulling down the second signal, in order to generate a determination result, wherein the assignment of the identifier of the electronic device is controlled according to the determination result.

### BACKGROUND OF THE INVENTION

### 1. Field of the Invention

The present invention is related to serial communications buses, and more particularly, to an electronic device for performing communication with a master device via a serial communications bus and a method for performing assignment of an identifier on the electronic device.

### 2. Description of the Prior Art

When a master device is connected to multiple slave devices via a serial communications bus, each of these slave devices typically needs to determine its own device identifier according to a voltage level of a selection pin, in order to allow the master device to determine which slave device is to be accessed by an instruction when sending the instruction with the aid of these device identifiers. For a chip product with a fewer number of pins, as the selection pin mentioned above occupies one pin of the chip product, some functions will be sacrificed and unable to be implemented. If implementing all functions is desired, the number of package pins will need to be increased to solve the aforementioned problems, but costs will be increased.

Thus, there is a need for a novel method and associated architecture to make the master device communicate with the slave devices via the serial communications bus without the aid of the selection pin, thereby solving the problem of the related art.

### SUMMARY OF THE INVENTION

An objective of the present invention is to provide an electronic device for performing communication with a master device via a serial communications bus, and a method for performing assignment of an identifier on the electronic device, which can solve the problem of the related art without introducing any side effect or in a way that is less likely to introduce side effects.

At least one embodiment of the present invention provides an electronic device for performing communication with a master device via a serial communications bus. The electronic device comprises a clock terminal, a data terminal and a determination circuit, wherein the determination circuit is coupled to the clock terminal and the data terminal. The clock terminal is configured to receive a first signal from the master device, and the data terminal is configured to receive a second signal from the master device. In addition, the determination circuit is configured to determine whether a time point of pulling down the first signal is earlier than a time point of pulling down the second signal, in order to generate a determination result. More particularly, the master device is coupled to multiple slave devices via the serial communications bus, the multiple slave devices comprise the electronic device, and assignment of an identifier of the electronic device is controlled according to the determination result.

At least one embodiment of the present invention provides a method for performing assignment of an identifier on an electronic device. The master device is coupled to multiple slave devices via a serial communications bus, wherein the multiple slave devices comprise the electronic device. The method comprises: utilizing a clock terminal of the electronic device to receive a first signal from the master device; utilizing a data terminal of the electronic device to receive a second signal from the master device; utilizing a determination circuit of the electronic device to determine whether a time point of pulling down the first signal is earlier than a time point of pulling down the second signal, in order to generate a determination result; and controlling assignment of an identifier of the electronic device according to the determination result.

The electronic device and the method provided by the embodiments of the present invention can make a data terminal and a clock terminal of a certain slave device be reversely connected, thereby making a detected start condition (e.g. timing of signals being pulled down) of this slave device different from other slave devices. When this slave device detects that the data terminal and the clock terminal thereof are reversely connected, a corresponding identifier assignment mechanism can be triggered. Thus, this slave device can complete the identifier assignment without using an additional selection pin.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a system according to an embodiment of the present invention.

FIG. 2 is a diagram illustrating a signal format conforming to an inter-integrated circuit (I²C) bus standard according to an embodiment of the present invention.

FIG. 3 is a diagram illustrating a first identifier assignment scheme of multiple slave devices connected to a same I²C bus according to an embodiment of the present invention.

FIG. 4 is a diagram illustrating a working flow of the first identifier assignment scheme shown in FIG. 3 according to an embodiment of the present invention.

FIG. 5 is a diagram illustrating a second identifier assignment scheme of multiple slave devices connected to a same I²C bus according to an embodiment of the present invention.

FIG. 6 is a diagram illustrating a working flow of the second identifier assignment scheme shown in FIG. 5 according to an embodiment of the present invention.

FIG. 7 is a diagram illustrating a working flow of a method for performing assignment of an identifier on an electronic device according to an embodiment of the present invention.

### DETAILED DESCRIPTION

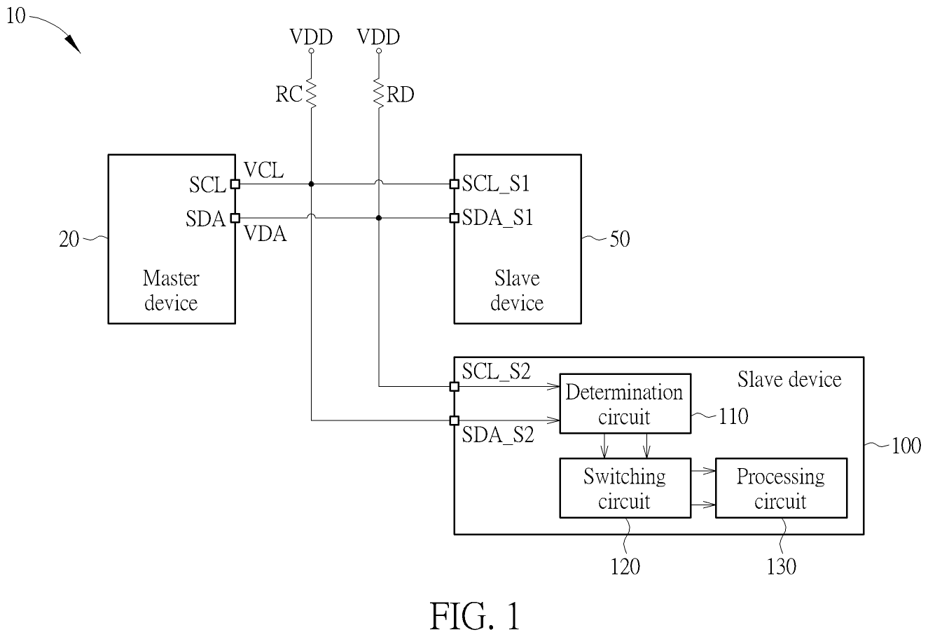

FIG. 1 is a diagram illustrating a system 10 according to an embodiment of the present invention. As shown in FIG. 1, the system 10 may comprise a master device 20 and multiple slave devices such as slave devices 50 and 100, where the master device 20 may be coupled to the slave devices 50 and 100 via an inter-integrated circuit (I²C) bus. The I²C bus may comprise a clock channel VCL and a data channel VDA, where the clock channel VCL may be coupled to a supply voltage VDD via a resistor RC, and the data channel VDA may be coupled to the supply voltage VDD via a resistor RD. In this embodiment, the master device 20, the slave devices 50 and the slave device 100 may each comprise a clock terminal and a data terminal. For example, the master device 20 may comprise a clock terminal SCL coupled to the clock channel VCL and a data terminal SDA coupled to the data channel VDA, the slave device 50 may comprise a clock terminal SCL_S1 coupled to the clock channel VCL and a data terminal SDA_S1 coupled to the data channel VDA, and the slave device 100 may comprise a clock terminal SCL_S2 coupled to the data channel VDA and a data terminal SDA_S2 coupled to the clock channel VCL. Based on the connection mentioned above, in comparison with the slave device 50 (e.g. the clock terminal SCL_S1 of the slave device 50 is coupled to the clock terminal SCL of the master device 20, and the data terminal SDA_S1 of the slave device 50 is coupled to the data terminal SDA of the master device 20), the clock terminal SCL_S2 and the data terminal SDA_S2 of the slave device 100 are reversely connected (e.g. the clock terminal SCL_S2 of the slave device 100 is coupled to the data terminal SDA of the master device 20, and the data terminal SDA_S2 of the slave device 100 is coupled to the clock terminal SCL of the master device 20).

In this embodiment, the slave device 100 may further comprise a determination circuit 110, a switching circuit 120 and a processing circuit 130 in addition to the clock terminal SCL_S2 and the data terminal SDA_S2. The determination circuit 110 may be coupled to the clock terminal SCL_S2 and the data terminal SDA_S2, the switching circuit 120 may be coupled to the determination circuit 110, and the processing circuit 130 may be coupled to the switching circuit 120. In this embodiment, the clock terminal SCL_S2 of the slave device 100 may receive a data signal transmitted via the data channel VDA from the master device 20, and the data terminal SDA_S2 of the slave device 100 may receive a clock signal transmitted via the clock channel VCL from the master device 20. The determination circuit 110 is configured to determine whether a time point of pulling down the data signal is earlier than a time point of pulling down the clock signal, in order to generate a determination result, where assignment of an identifier (ID) such as a device ID of the slave device 100 is controlled according to the determination result. In addition, the switching circuit 120 is configured to selectively switch utilization of a signal received by the clock terminal SCL_S2 and a signal received by the data terminal SDA_S2. For example, the switching circuit 120 may take one of the signal received by the clock terminal SCL_S2 and the signal received by the data terminal SDA_S2 as a clock signal for being utilized by the processing circuit 130, and take the other signal as a data signal for being utilized by the processing circuit 130. In some embodiments, the architecture of the slave device 50 may be the same as or different from the slave device 100 (e.g. the slave device 50 may comprise circuits that are the same or similar to the determination circuit 110, the switching circuit 120 and the processing circuit 130 for performing corresponding operations), but the present invention is not limited thereto.

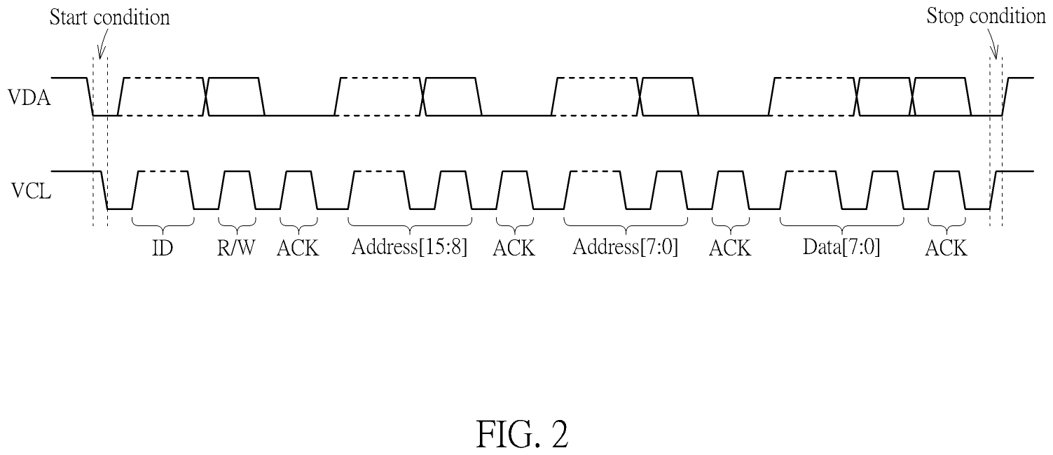

FIG. 2 is a diagram illustrating a signal format conforming to an I²C bus standard according to an embodiment of the present invention, where a signal labeled “VDA” in FIG. 2 represents the data signal transmitted via the data channel VDA, and a signal labeled “VCL” represents the clock signal transmitted via the clock channel VCL. In this embodiment, the clock signal may utilize a corresponding number of clock cycles to specify time intervals of multiple fields within an access instruction, and values of the data signal in these time intervals may represent values of the multiple fields, respectively. For example, an access instruction may comprise an ID, a read/write value (labeled “R/W” in FIG. 2), one or more acknowledge values (labeled “ACK” in FIG. 2), one or more addresses (labeled “Address [15:8]”, “Address [7:0]” in FIG. 2), and one or more data values (labeled “Data [7:0]” in FIG. 2). In addition, pulling down the data signal first and then pulling down the clock signal may be taken as a start condition of the access instruction, and pulling up the clock signal first and then pulling up the data signal may be taken as a stop condition of the access instruction.

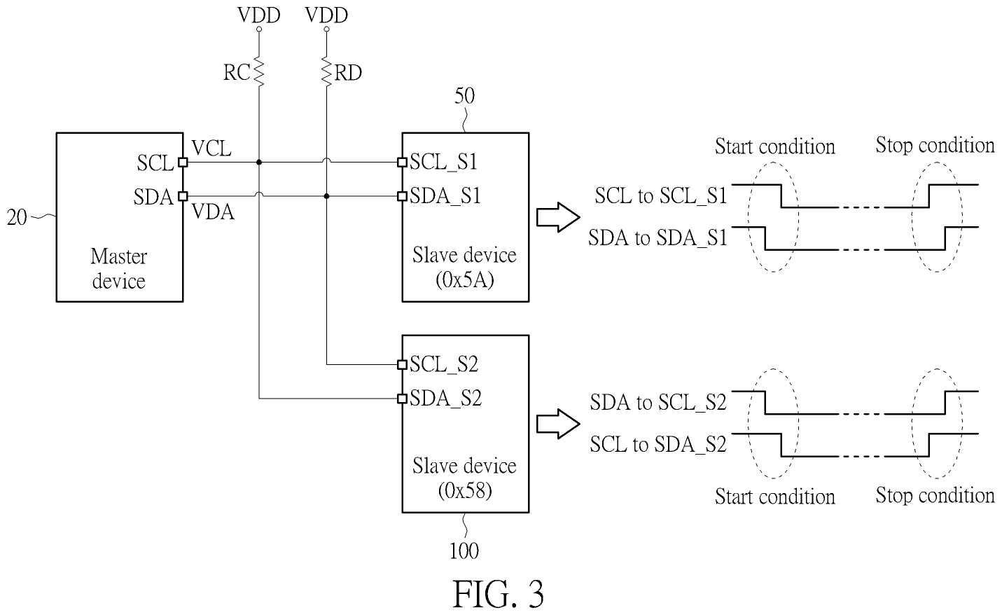

FIG. 3 is a diagram illustrating a first identifier assignment scheme of the slave devices 50 and 100 connected to a same I²C bus according to an embodiment of the present invention. In this embodiment, the slave devices 50 and 100 may each have a first candidate ID such as 0x5A and a second candidate ID such as 0x58, and the slave devices 50 and 100 may each select one of the IDs 0x5A and 0x58 to be an ID thereof according to a determination result thereof. For example, as the clock terminal SCL_S1 of the slave device 50 is coupled to the clock terminal SCL of the master device 20 and the data terminal SDA_S1 of the slave device 50 is coupled to the data terminal SDA of the master device 20, the slave device 50 may detect that a time point of pulling down a signal transmitted from the data terminal SDA to the data terminal SDA_S1 is earlier than a time point of pulling down a signal transmitted from the clock signal SCL to the clock signal SCL_S1, and the slave device 50 may accordingly select the ID 0x5A to be the ID of the slave device 50. In addition, as the time point of pulling down the signal transmitted from the data terminal SDA to the data terminal SDA_S1 the data terminal SDA is earlier than the time point of pulling down the signal transmitted from the clock signal SCL to the clock signal SCL_S1, the slave device 50 (e.g. the switching circuit 120 therein) may prevent switching the utilization of the signal received by the clock terminal SCL_S1 and the signal received by the data terminal SDA_S1, in order to take the signal received by the clock terminal SCL_S1 as a clock signal and take the signal received by the data terminal SDA_S1 as a data signal.

In comparison with the slave device 50, as the clock terminal SCL_S2 of the slave device 100 is coupled to the data terminal SDA of the master device 20 and the data terminal SDA_S2 of the slave device 100 is coupled to the clock terminal SCL of the master device 20, the slave device 100 may detect that a time point of pulling down a signal transmitted from the data terminal SDA to the clock terminal SCL_S2 is earlier than a time point of pulling down a signal transmitted from the clock terminal SCL to the data terminal SDA_S2, and the slave device 100 may accordingly select the ID 0x58 to be the ID of the slave device 100. In addition, as the time point of pulling down the signal transmitted from the data terminal SDA to the clock terminal SCL_S2 is earlier than the time point of pulling down the signal transmitted from the clock terminal SCL to the data terminal SDA_S2, the slave device 100 (e.g. the switching circuit 120 therein) may switch utilization of the signal received by the clock terminal SCL_S2 and the signal received by the data terminal SDA_S2, in order to take the signal received by the clock terminal SCL_S2 as a data signal and take the signal received by the data terminal SDA_S2 as a clock signal.

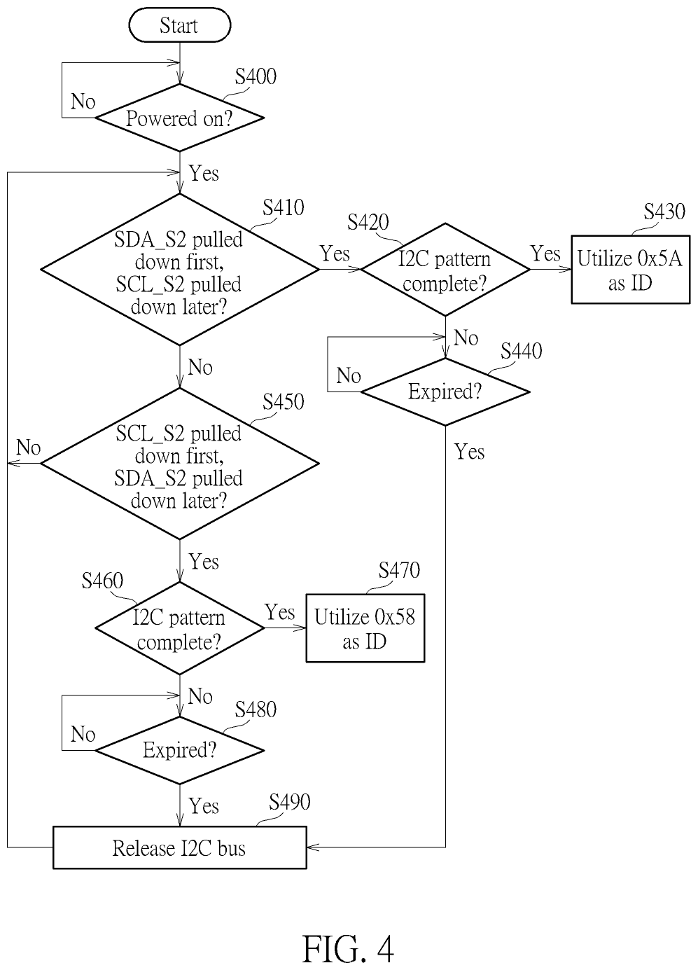

FIG. 4 is a diagram illustrating a working flow of the first identifier assignment scheme shown in FIG. 3 according to an embodiment of the present invention, where the working flow shown in FIG. 3 may be executed by any slave device (e.g. the slave device 100) coupled to the master device 20 via the I²C bus. It should be noted that the working flow shown in FIG. 4 is for illustrative purposes only, and is not meant to be a limitation of the present invention. For example, one or more steps may be added, deleted or modified in the working flow shown in FIG. 4. In addition, if a same result can be obtained, these steps do not have to be executed in the exact order shown in FIG. 4.

In Step S400, the slave device 100 may determine whether the I²C bus is powered on (e.g. whether the supply voltage VDD is turned on). If the determination result shows “Yes”, the working flow proceeds with Step S410. If the determination result shows “No”, the working flow proceeds with Step S400.

In Step S410, the slave device 100 may determine whether a time point of pulling down a voltage level of the data terminal SDA_S2 is earlier than a time point of pulling down a voltage level of the clock terminal SCL_S2 (labeled “SDA_S2 pulled down first, SCL_S2 pulled down later?” in FIG. 4 for brevity). If the determination result shows “Yes”, the working flow proceeds to Step S420. If the determination result shows “No”, the working flow proceeds to Step S450.

In Step S420, the slave device 100 may determine whether a signal pattern from the I²C bus is complete (labeled “I²C pattern complete?” in FIG. 4 for brevity) by, for example, determining whether a signal format received via the I²C bus includes the ID, the read/write value, the acknowledge value, the address and the data value mentioned above. If the determination result shows “Yes”, the working flow proceeds to Step S430. If the determination result shows “No”, the working flow proceeds to Step S440.

In Step S430, the slave device 100 may utilize the ID 0x5A to be the ID of the slave device 100 (labeled “Utilize 0x5A as ID” in FIG. 4 for brevity).

In Step S440, the slave device 100 may determine whether a time period starting from detecting the start condition has expired (labeled “Expired?” in FIG. 4 for brevity). If the determination result shows “Yes”, the working flow proceeds to Step S490. If the determination result shows “No”, the working flow proceeds to Step S440 to re-execute the determination of whether the time period has expired.

In Step S450, the slave device 100 may determine whether the time point of pulling down the voltage level of the clock terminal SCL_S2 is earlier than the time point of pulling down the voltage level of the data terminal SDA_S2 (labeled “SCL_S2 pulled down first, SDA_S2 pulled down later?” in FIG. 4 for brevity). If the determination result shows “Yes”, the working flow proceeds to Step S460. If the determination result shows “No”, the working flow proceeds to Step S410.

In Step S460, the slave device 100 may determine whether the signal pattern from the I²C bus is complete (labeled “I²C pattern complete?” in FIG. 4 for brevity) by, for example, determining whether the signal format received via the I²C bus includes the ID, the read/write value, the acknowledge value, the address and the data value mentioned above. If the determination result shows “Yes”, the working flow proceeds to Step S470. If the determination result shows “No”, the working flow proceeds to Step S480.

In Step S470, the slave device 100 may utilize the ID 0x58 to be the ID of the slave device 100 (labeled “Utilize 0x58 as ID” in FIG. 4 for brevity).

In Step S480, the slave device 100 may determine whether the time period starting from detecting the start condition has expired (labeled “Expired?” in FIG. 4 for brevity). If the determination result shows “Yes”, the working flow proceeds to Step S490. If the determination result shows “No”, the working flow proceeds to Step S480 to re-execute the determination of whether the time period is expired.

In Step S490, the slave device 100 may release the control of the I²C bus (labeled “Release I²C bus” in FIG. 4 for brevity), and the working flow returns to Step S410.

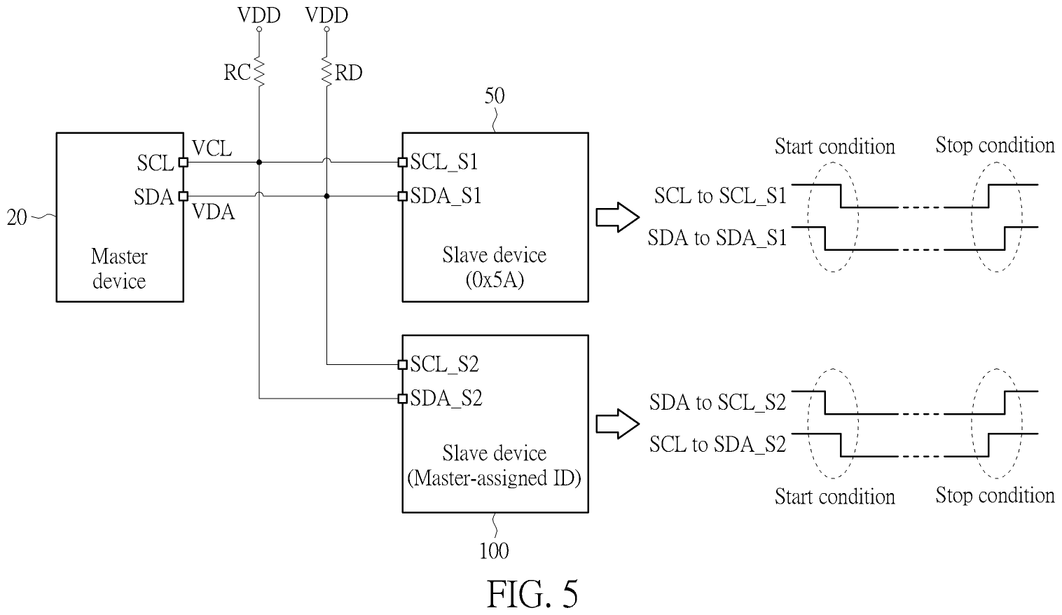

FIG. 5 is a diagram illustrating a second identifier assignment scheme of the slave devices 50 and 100 connected to the same I²C bus according to an embodiment of the present invention. In this embodiment, each of the slave devices 50 and 100 may selectively utilize an assigned ID sent from the master device 20 according to the determination result thereof. For example, as the clock terminal SCL_S1 of the slave device 50 is coupled to the clock terminal SCL of the master device 20 and the data terminal SDA_S1 of the slave device 50 is coupled to the data terminal SDA of the master device 20, the slave device 50 may detect that the time point of pulling down the signal transmitted from the data terminal SDA to the data terminal SDA_S1 is earlier than the time point of pulling down the signal transmitted from the clock signal SCL to the clock signal SCL_S1, and the slave device 50 may utilize a default ID such as 0x5A to be the ID of the slave device 50 and prevent utilizing the assigned ID sent from the master device 20. In addition, as the time point of pulling down the signal transmitted from the data terminal SDA to the data terminal SDA_S1 the data terminal SDA is earlier than the time point of pulling down the signal transmitted from the clock signal SCL to the clock signal SCL_S1, the slave device 50 (e.g. the switching circuit 120 therein) may prevent switching the utilization of the signal received by the clock terminal SCL_S1 and the signal received by the data terminal SDA_S1, in order to take the signal received by the clock terminal SCL_S1 as a clock signal and take the signal received by the data terminal SDA_S1 as a data signal.

In comparison with the slave device 50, as the clock terminal SCL_S2 of the slave device 100 is coupled to the data terminal SDA of the master device 20 and the data terminal SDA_S2 of the slave device 100 is coupled to the clock terminal SCL of the master device 20, the slave device 100 may detect that the time point of pulling down the signal transmitted from the data terminal SDA to the clock terminal SCL_S2 is earlier than the time point of pulling down the signal transmitted from the clock terminal SCL to the data terminal SDA_S2, and the slave device 100 may utilize the assigned ID sent from the master device 20 (more particularly, an ID carried by a first instruction sent from the master device 20 after the system 10 is powered on) to be the ID of the slave device 100. In addition, as the time point of pulling down the signal transmitted from the data terminal SDA to the clock terminal SCL_S2 is earlier than the time point of pulling down the signal transmitted from the clock terminal SCL to the data terminal SDA_S2, the slave device 100 (e.g. the switching circuit 120 therein) may switch the utilization of the signal received by the clock terminal SCL_S2 and the signal received by the data terminal SDA_S2, in order to take the signal received by the clock terminal SCL_S2 as a data signal and take the signal received by the data terminal SDA_S2 as a clock signal.

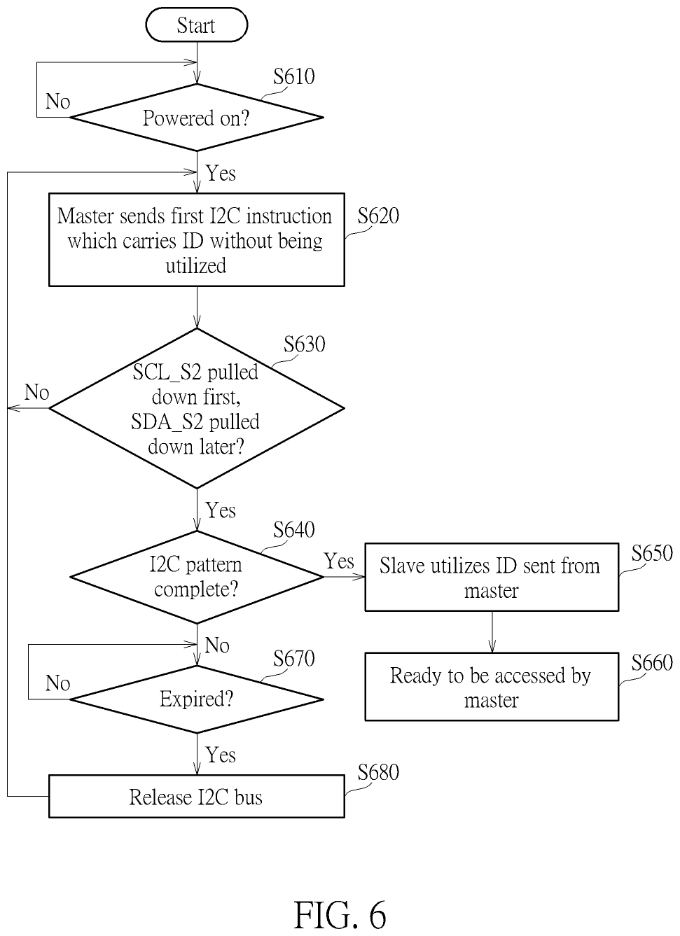

FIG. 6 is a diagram illustrating a working flow of the second identifier assignment scheme shown in FIG. 5 according to an embodiment of the present invention, where the working flow shown in FIG. 6 may be executed by any slave device (e.g. the slave device 100) coupled to the master device 20 via the I²C bus. It should be noted that the working flow shown in FIG. 6 is for illustrative purposes only, and is not meant to be a limitation of the present invention. For example, one or more steps may be added, deleted or modified in the working flow shown in FIG. 6. In addition, if a same result can be obtained, these steps do not have to be executed in the exact order shown in FIG. 6.

In Step S610, the slave device 100 may determine whether the I²C bus is powered on (e.g. whether the supply voltage VDD is turned on). If the determination result shows “Yes”, the working flow proceeds with Step S620. If the determination result shows “No”, the working flow proceeds with Step S610.

In Step S620, the slave device 100 may receive a first I²C bus instruction sent from the master device 20, and the I²C bus instruction carries an ID which is not utilized (labeled “Master sends first I²C instruction which carries ID without being utilized” in FIG. 6 for brevity).

In Step S630, the slave device 100 may determine whether the time point of pulling down the voltage level of the clock terminal SCL_S2 is earlier than the time point of pulling down the voltage level of the data terminal SDA_S2 (labeled “SCL_S2 pulled down first, SDA_S2 pulled down later?” in FIG. 6 for brevity). If the determination result shows “Yes”, the working flow proceeds with Step S640. If the determination result shows “No”, the working flow proceeds with Step S620.

In Step S640, the slave device may determine whether the signal pattern from the I²C bus is complete (labeled “I²C pattern complete?” in FIG. 6 for brevity) by, for example, determining whether the signal format received via the I²C bus includes the ID, the read/write value, the acknowledge value, the address and the data value mentioned above. If the determination result shows “Yes”, the working flow proceeds to Step S650. If the determination result shows “No”, the working flow proceeds to Step S670.

In Step S650, the slave device 100 may utilize the ID sent from the master device 20 to be the ID of the slave device 100 (labeled “Slave utilizes ID sent from master” in FIG. 6 for brevity).

In Step S660, the slave device 100 is ready to be accessed by the master device 20 (labeled “Ready to be accessed by master” in FIG. 6 for brevity).

In Step S670, the slave device 100 may determine whether the time period starting from detecting the start condition has expired (labeled “Expired?” in FIG. 6 for brevity). If the determination result shows “Yes”, the working flow proceeds to Step S680. If the determination result shows “No”, the working flow proceeds to Step S670 to re-execute the determination of whether the time period has expired.

In Step S680, the slave device 100 may release the control of the I²C bus (labeled “Release I²C bus” in FIG. 6 for brevity), and the working flow returns to Step S620.

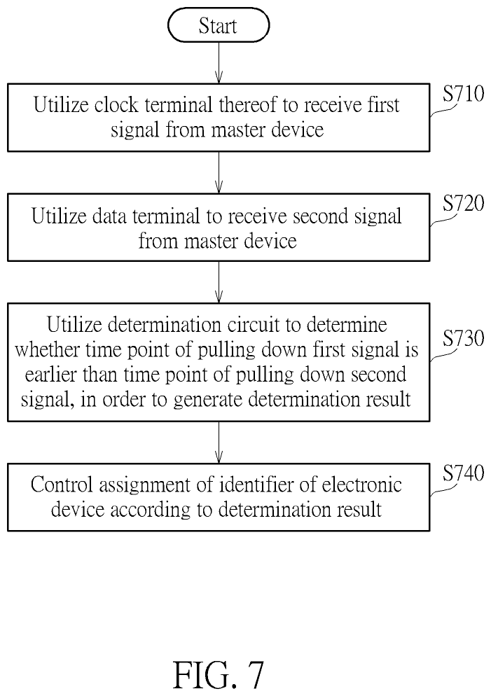

FIG. 7 is a diagram illustrating a working flow of a method for performing assignment of an identifier on an electronic device according to an embodiment of the present invention, where a master device (e.g. the master device 20 shown in FIG. 1) may be coupled to multiple slave devices (e.g. the slave devices 50 and 100 shown in FIG. 1) via a serial communications bus (e.g. the I²C bus), and the electronic device represents one of the multiple slave devices. It should be noted that the working flow shown in FIG. 7 is for illustrative purposes only, and is not meant to be a limitation of the present invention. For example, one or more steps may be added, deleted or modified in the working flow shown in FIG. 7. In addition, if a same result can be obtained, these steps do not have to be executed in the exact order shown in FIG. 7.

In Step S710, the electronic device may utilize a clock terminal thereof to receive a first signal from the master device.

In Step S720, the electronic device may utilize a data terminal thereof to receive a second signal from the master device.

In Step S730, the electronic device may utilize a determination circuit thereof to determine whether a time point of pulling down the first signal is earlier than a time point of pulling down the second signal, in order to generate a determination result.

In Step S740, the electronic device may control assignment of an identifier of the electronic device according to the determination result.

To summarize, the embodiments of the present invention can control the assignment of the ID according to whether the clock terminal and the data terminal of the slave device are reversely connected or not, and more particularly, may utilize the default candidate ID or the ID sent from the master device to determine the ID of the slave device. Thus, the ID of the slave device can be set without using any additional selection pin. In addition, the embodiments of the present invention will not greatly increase additional costs. Thus, the present invention can solve the problem without introducing any side effect or in a way that is less likely to introduce side effects.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic device for performing communication with a master device via a serial communications bus, comprising:
a clock terminal, configured to receive a first signal from the master device;
a data terminal, configured to receive a second signal from the master device; and
a determination circuit, coupled to the clock terminal and the data terminal, configured to determine whether a time point of pulling down the first signal is earlier than a time point of pulling down the second signal, in order to generate a determination result;
wherein the master device is coupled to multiple slave devices via the serial communications bus, the electronic device represents one of the multiple slave devices, and assignment of an identifier of the electronic device is controlled according to the determination result.

2. The electronic device of claim 1, wherein the electronic device has a first candidate identifier and a second candidate identifier, and the electronic device selects one of the first candidate identifier and the second candidate identifier to be the identifier of the electronic device according to the determination result.

3. The electronic device of claim 1, wherein the electronic device selectively utilizes an assigned identifier sent from the master device according to the determination result.

4. The electronic device of claim 3, wherein when the determination result indicates that the time point of pulling down the second signal is earlier than the time point of pulling down the first signal, the electronic device prevents utilizing the assigned identifier sent from the master device.

5. The electronic device of claim 3, wherein when the determination result indicates that the time point of pulling down the first signal is earlier than the time point of pulling down the second signal, the electronic device utilizes the assigned identifier sent from the master device to be the identifier of the electronic device.

6. The electronic device of claim 1, further comprising:
a switching circuit, configured to selectively switch utilization of the first signal and the second signal according to the determination result.

7. The electronic device of claim 6, wherein when the determination result indicates that the time point of pulling down the second signal is earlier than the time point of pulling down the first signal, the switching circuit prevents switching the utilization of the first signal and the second signal, to make the electronic device take the first signal as a clock signal and take the second signal as a data signal.

8. The electronic device of claim 6, wherein when the determination result indicates that the time point of pulling down the first signal is earlier than the time point of pulling down the second signal, the switching circuit switches the utilization of the first signal and the second signal, to make the electronic device take the first signal as a data signal and take the second signal as a clock signal.

9. The electronic device of claim 1, wherein the serial communications bus is an inter-integrated circuit (I²C) bus.

10. A method for performing assignment of an identifier on an electronic device, wherein a master device is coupled to multiple slave devices via a serial communications bus, the multiple slave devices comprise the electronic device, and the method comprises:
utilizing a clock terminal of the electronic device to receive a first signal from the master device;
utilizing a data terminal of the electronic device to receive a second signal from the master device;
utilizing a determination circuit of the electronic device to determine whether a time point of pulling down the first signal is earlier than a time point of pulling down the second signal, in order to generate a determination result; and
controlling assignment of an identifier of the electronic device according to the determination result.

11. The method of claim 10, wherein the electronic device has a first candidate identifier and a second candidate identifier, and controlling the assignment of the identifier of the electronic device according to the determination result comprises:
selecting one of the first candidate identifier and the second candidate identifier to be the identifier of the electronic device according to the determination result.

12. The method of claim 10, wherein controlling the assignment of the identifier of the electronic device according to the determination result comprises:
selectively utilizing an assigned identifier sent from the master device according to the determination result.

13. The method of claim 12, wherein selectively utilizing the assigned identifier sent from the master device according to the determination result comprises:
in response to the determination result indicating that the time point of pulling down the second signal is earlier than the time point of pulling down the first signal, preventing utilizing the assigned identifier sent from the master device.

14. The method of claim 12, wherein selectively utilizing the assigned identifier sent from the master device according to the determination result comprises:
in response to the determination result indicating that the time point of pulling down the first signal is earlier than the time point of pulling down the second signal, utilizing the assigned identifier sent from the master device to be the identifier of the electronic device.

15. The method of claim 10, further comprising:
utilizing a switching circuit of the electronic device to selectively switch utilization of the first signal and the second signal according to the determination result.

16. The method of claim 15, wherein utilizing the switching circuit of the electronic device to selectively switch the utilization of the first signal and the second signal according to the determination result comprises:
in response to the determination result indicating that the time point of pulling down the second signal is earlier than the time point of pulling down the first signal, preventing switching the utilization of the first signal and the second signal, to make the electronic device take the first signal as a clock signal and take the second signal as a data signal.

17. The method of claim 15, wherein utilizing the switching circuit of the electronic device to selectively switch the utilization of the first signal and the second signal according to the determination result comprises:
in response to the determination result indicates that the time point of pulling down the first signal is earlier than the time point of pulling down the second signal, switching the utilization of the first signal and the second signal, to make the electronic device take the first signal as a data signal and take the second signal as a clock signal.

18. The method of claim 10, wherein the serial communications bus is an inter-integrated circuit (I²C) bus.
